(19) United States
(12) Patent Application Publication
(10) Pub. No.: US 2003/0033160 A1
(43) Pub. Date: Feb. 13, 2003

(54) System for supporting business activities and system for preparing data for supporting business activities

(76) Inventor: Masako Tabei, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/055,961

(22) Filed: Jan. 28, 2002

(30) Foreign Application Priority Data
Aug. 9, 2001 (JP) 2001-242405
Sep. 21, 2001 (JP) 2001-289184

(51) Int. Cl. G06F 17/60

(52) U.S. Cl. 705/1

(57) ABSTRACT

A business activity support system in which prospective customers are extracted beforehand, and a system for preparing suitable data for persuading the prospective customers are proposed. A list of parties to be called in a predetermined area is prepared from a telephone directory data file and a prospective customer register is prepared by making calls based thereon. From the prospective customer register and a map data file, a customer list and a map of parties to be visited are output, and business activity support data taken out of data base files are output to a memory medium. A salesman visits a customer according to such information and has a business talk while displaying the contents of the memory medium on the display of a mobile computer.

### BACKGROUND OF THE INVENTION

This invention relates to a system for supporting business activities, particularly visiting business activities and a system for preparing data for supporting various business activities, particularly visiting activities for opening franchise shops.

Among business activities, visiting customers and explaining are very effective in inducing them. But such explanations are sometimes ignored by customers who have no interest. Thus, so-called house-to-house visits are extremely inefficient and burdens are large for salesmen.

Thus, targets should be narrowed down to those from whom demand can be expected before starting business activities. But the investigating method for narrowing down targets is difficult. Further, it is also extremely difficult to collect data suitable for persuading the thus narrowed-down prospective customers.

An object of the present invention is to provide a system for supporting business activities in which prospective customers are extracted beforehand.

Another object of the present invention is to provide a system for preparing a material for extracting prospective customers and data suitable for persuading the prospective customers.

### SUMMARY OF THE INVENTION

According to this invention, there is provided a business activity support system comprising the steps of extracting customers to be called in a given territory from a telephone directory data base, calling the customers thus extracted to prepare a list of prospective customers, determining the locations of the prospective customers on a map based on the information about the address of the prospective customers and a map data base to prepare a map indicating the locations of the prospective customers, and visiting the prospective customers by use of the map indicating the locations of the prospective customers.

According to this invention, there is also provided a system for preparing business activity support data, the system comprising the steps of extracting customers to be called in a given territory from a telephone directory data base, calling the customers to prepare prospective customer data, determining the locations of the prospective customers on a map based on information about the address of the prospective customer and a map data base to prepare a map indicating the locations of the prospective customers, preparing a map that shows a commercial territory, consumers and competitors around the locations of the prospective customers, and preparing data that shows consumption tendencies in the commercial territory.

Preferably, the data prepared in all of said steps are adapted to be displayed on a mobile computer through the Internet or a memory medium.

In the steps of extracting calling parties, positions of the parties to be called may be indicated on a map beforehand using a map data base. Also, this step may include the step of preparing data that shows profitability.

### BRIEF DESCRIPTION OF THE DRAWINGS

FIG. 1 is a diagram showing an example of a system for supporting business activities and a system for preparing business activity support data according to this invention;

FIG. 2 is a flowchart showing the process of the system for supporting business activities and a system for preparing business activity support data; and

FIG. 3 is a plan view showing an example of the business activity support data.

### DETAILED DESCRIPTION OF THE PREFERRED EMBODIMENT

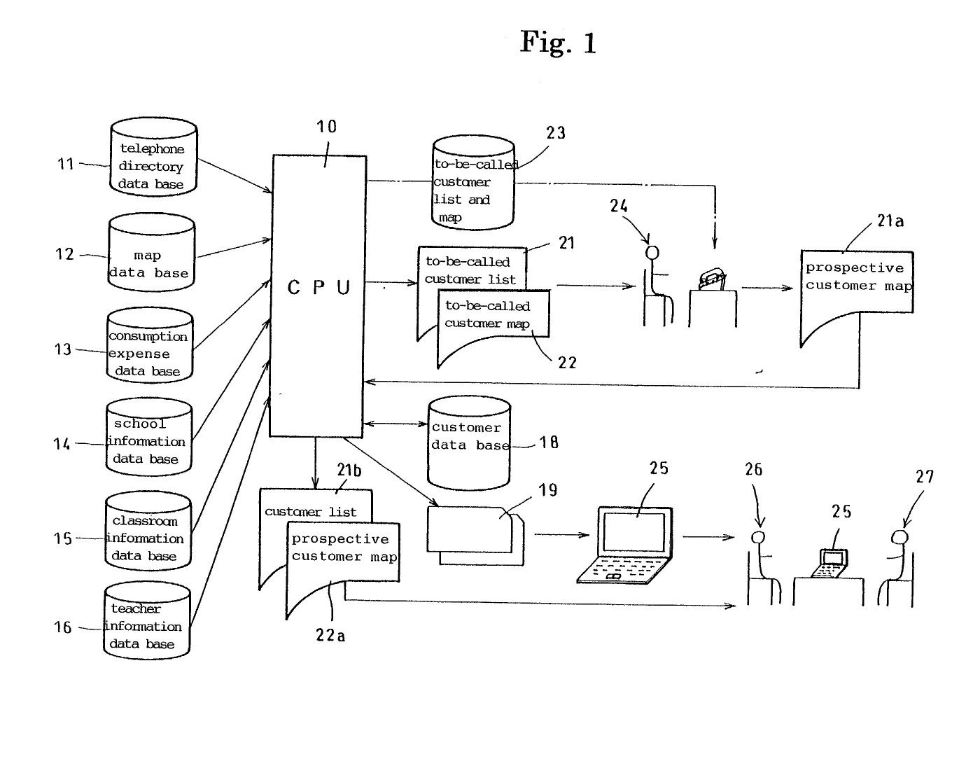

An embodiment of the business activity support system and the business activity support data preparing system according to this invention will be described with reference to FIGS. 1-3. FIG. 1 is a flow chart of the support system according to this invention. A central processing unit (CPU) 10 such as a personal computer has a telephone directory data base file 11 in which are registered nation-wide telephone numbers, names, addresses, occupations, etc., a map data base file 12 from which one can search any point on the map from an address, a consumption expense data base file 13 from which one can estimate expenses for such items as education, food, traffic and communication, cultural and entertainment, etc., a school information data base file 14 in which are registered the location, subjects taught and the number of students of every school, a classroom information data base file 15 in which are registered the location of classrooms such as cram schools, the number of students thereof, etc., and a teacher information data base file 16, etc. The CPU is used to perform various operations using these data base files 11-16 to output data for supporting business activities.

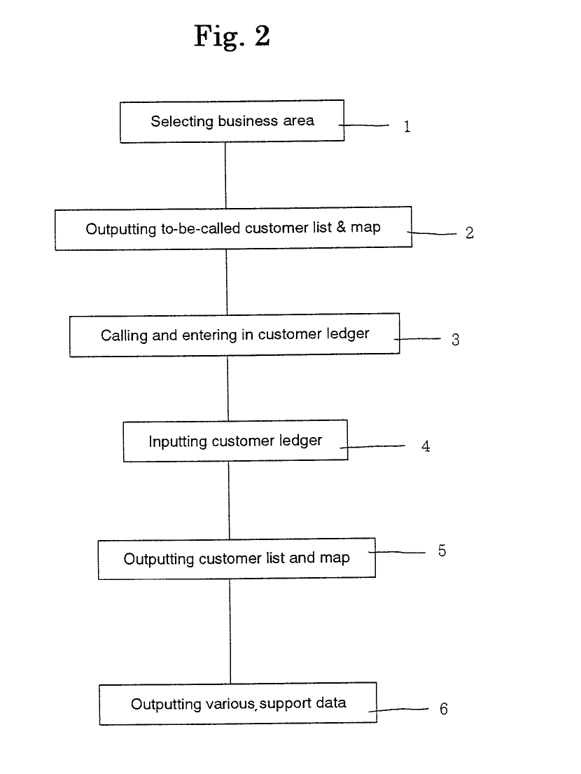

One example of this process will be described with reference to FIGS. 1 and 2. In Step 1, each business area is divided into several sections. For example, if a certain prefecture is selected as a target, it is divided into a plurality of sections, e.g. towns. Of course, these sections are not limited to administrative sections but may be area codes of telephone numbers. This division is preferably made automatically on the display.

Next, in Step 2, a to-be-called customer list 21 and a to-be-called customer map 22 on which the positions of the customers to be called are indicated are outputted as a register. At the same time, it may be output as to be-called customer lists and map files 23 for individual sections. It will be convenient if the to-be-called customer list 21 is in such a form that it can also be used as the below-described customer ledger.

Consulting the thus outputted to-be-called customer list 21 and the map 22, an operator 24 talks over the phone in Step 3 to collect various information such as the place of employment, age, sex, feeling to particular goods or services, etc. to seek potential demand. Such information is written on the to-be-called customer list 21. At this time, using the file 23, the operator 24 may input data while consulting the to-be-called customer list displayed on the display of a personal computer. Also, the system may be adapted such that by clicking a telephone number on the to-be-called customer list, a call can be made automatically.

By such work, prospective targets are specified, and a prospective customer ledger 21a or prospective customer data is prepared. As described above, if the to be-called customer list and the customer ledger 21a are made in the same format, by filling in any information on the to-be-called customer list, it can be used as the customer ledger 21a, too. This is entered into the central processing unit 10 in Step 4. If the calling and the information entering into the customer ledger in Step 3 are carried out using the to-be-called customer list 21 and the map file 23, the customer ledger 21a as the register is not necessarily needed. Also, the entering (type-in) work in Step 4 may be omitted.

The central processing unit 10 outputs as registers a list 21b of prospective customers to be visited and a map 22a indicating their positions (Step 5) based on data in the customer ledger 21a and the map data base file 12. The prospective customer list 21b is preferably in the same format as the customer ledger 21a. Other data such as tax payment amount can be added as necessary. The contents of the customer list 21b and the prospective customer map 22a should be inputted into a memory medium 19 such as a card memory. The memory medium 19 can be read on a mobile computer 25 which is carried by a salesman 26.

Next, in Step 6, a map showing the commercial territory of each prospective customer e.g. prospective franchisee is outputted from the map data base file 12 to the memory medium 19. Of course, it may be adapted to be accessible through the Internet. If cram schools or classrooms are to be opened, the locations, names and sizes of elementary schools and junior and senior high schools, and the locations, names and sizes of their competitors should be read out of the school information data base file 14 and the classroom information data base file 15 and entered in the commercial territory map. Further, consumption tendencies such as educational expenditures in the corresponding territory are outputted. Such educational expenditures may be outputted separately for national or public elementary schools, private elementary schools, national or public junior highs, private junior highs, national or public senior highs and private senior highs. Besides, it is also possible to output the population of the territory classified by the age or sex and the data on teachers (file 16).

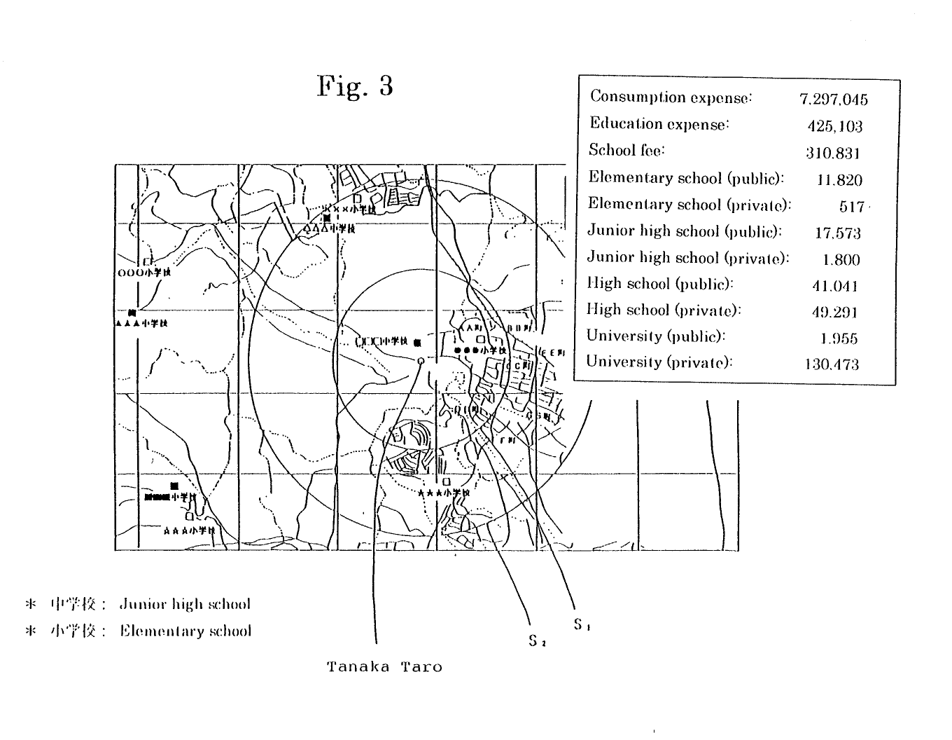

FIG. 3 shows an example in which information from the memory medium 19 such as a card memory or from the Internet is displayed on the display of a mobile computer 25. In the figure, “Tanaka Taro” is the name of a prospective customer, S1 and S2 are 1 km-radius and 2 km-radius circles, respectively. The population and consumption expenditures are outputted as the total of items for this circle or each 1 km range. Of course, the data base files 11-16 may be consolidated or suitably divided if required.

Carrying the thus output customer list 21b and map 22a showing the locations of the customers to be visited, as well as the memory medium 19 in which are condensed various support data, and the mobile computer 25, a salesman 26 visits a prospective customer 27 for a business talk. If the business is about introduction into a franchise, by presenting to the customer 27 during the business talk a map of the commercial territory, competitors, composition of the population, income breakdown, consumption expenditures, number of customers, shares, profitability, process and expenses until openings, etc. through the memory medium 19 by means of software stored in the mobile computer 25, it is possible to have a business talk smoothly. The results of business negotiation are filed in the customer data base file 18 for use for customer control in the future.

According to the business support system and the business activity support data preparing system of this invention, as described above, from telephone number data which substantially covers a certain section entirely, the prospective customer data are prepared beforehand by making calls, and the map data that show locations of these prospective customers are output. Salesmen visit the customers carrying the customer data and map data and have a business talk while consulting various data that support their business activities. Thus, it is possible to save wasteful labor of salesmen. Also, smooth negotiation is possible based on accurate data, so that such negotiations will come to a success at a high rate.

What is claimed is:

1. A business activity support system comprising the steps of extracting customers to be called in a given territory from a telephone directory data base, calling the customers thus extracted to prepare a list of prospective customers, determining the locations of the prospective customers on a map based on the information about the address of the prospective customers and a map data base to prepare a map indicating the locations of the prospective customers, and visiting the prospective customers by use of said map indicating the locations of the prospective customers.

2. The business activity support system as claimed in claim 1, wherein said map indicating the locations of the prospective customers is recorded on a memory medium from which a mobile computer can read.

3. The business activity support system as claimed in claim 2 wherein commercial territory map, competitors, the number of prospective customers and profitability are displayed on said mobile computer.

4. The business activity support system comprising the steps of extracting customers to be called in a given territory from a telephone directory data base, indicating the locations of the customers to be called on a map from a map data base, calling the customers thus extracted to prepare a list of the prospective customers, determining the locations of the prospective customers, outputting a map indicating the locations of the prospective customers, and visiting the prospective customers by use of said map indicating the locations of the prospective customers.

5. A system for preparing business activity support data, the system comprising the steps of extracting customers to be called in a given territory from a telephone directory data base, calling the customers to prepare prospective customer data, determining the locations of the prospective customers on a map based on information about the address of the prospective customer and a map data base to prepare a map indicating the locations of the prospective customers, preparing a map that shows a commercial territory, consumers and competitors around the locations of the prospective customers, and preparing data that shows consumption tendencies in the commercial territory.

6. A system for preparing business activity support data, the system comprising the steps of extracting customers to be called in a given territory from a telephone directory data base, indicating the locations of the customers on a map from a map data base, calling the customers to prepare the prospective customer data, preparing a map indicating the locations of the prospective customers, preparing a map showing the locations of the prospective customer, preparing a map that shows a commercial territory, consumers and competitors around the locations of the prospective customers, and preparing data that shows consumption tendencies in the commercial territory.

7. The system as claimed in claim 5 or 6 wherein the data prepared in all of said steps can be displayed on a mobile computer through the Internet or a memory medium.

8. The system as claimed in any of claims 5-7 further comprising the step of preparing data regarding profitability.
